(19) United States
(12) Patent Application Publication
(10) Pub. No.: US 2019/0252907 A1
(43) Pub. Date: Aug. 15, 2019

(54) CONTINUOUS POWER SUPPLY FOR ELECTRIC VEHICLES

(71) Applicant: Hyiamang Safo Odoom, Akron, OH (US)

(72) Inventor: Hyiamang Safo Odoom, Akron, OH (US)

(21) Appl. No.: 16/530,388

(22) Filed: Oct. 30, 2017

(51) Int. Cl. H02J 7/14; B60L 50/51

(52) U.S. Cl. CPC H02J 7/14; B60L 50/51

(57) ABSTRACT

An electric motor loses its power as the battery of the vehicle that had stored the vehicle's power runs flat because of the depletion of electricity from the battery pack, and an attached alternating induction motor (alternator) will supply power to the battery pack to replenish this loss of power supply, thus giving the vehicle continuous power to travel and will therefore not stop at an electric power supply dispensing station to recharge its battery but will continue its journey because the vehicle has uninterrupted power supply from the alternating induction motor that has wires that connect to the battery pack and to the controller for distribution to parts of the vehicle (for the operation of the vehicle).

### BACKGROUND OF THE INVENTION

The current conception relates to power supply method for a vehicle, and more especially to an all-electric vehicle that needs not stop to recharge its battery pack at a recharging station or even a power grid at the garage, but rather an alternating induction motor circuit is integrated directly into the battery pack, such that once the vehicle is started, the loss of stored power experienced in the battery is immediately replaced by the charge from the alternating circuit (like jumpstarting a vehicle) therefore compensating for the loss of power and this gives continuous supply of electricity to the battery pack so that the vehicle will not stop to recharge along the way or even at home as once the vehicle is started recharge the battery begins; (this acts like plugging in a laptop to charge the battery and still be using the computer to surf the web or typing as the laptop continuously receives its electric charge.

### DESCRIPTION OF THE PRIOR ART

In the prior art, a conventional electric vehicle uses a battery pack as its power supply in the pure electric vehicle compared to direct circuit of hybrids and plug-in hybrid vehicles that use electric energy sources to maximize their driving range. It is also on record that electric vehicles use electricity stored in the battery pack to power the electric motor and turn the wheels although you could not drive it for about two hundred kilometers before the batteries run flat. This loss of power over long distance remains the Achilles heel of electric vehicles. There are, however, charging stations like public charging stations, and Tesla's company-funded Supercharger network in many areas to mitigate against this challenge. Public charging stations remain scarce, also, charging of the vehicle's battery will be a problem for individuals who need to drive more than 200 miles or so; again, it will be difficult for people who do not have garages to plug-in their vehicles to recharge overnight.

The U.S. Pat. No. 4,348,628, the patent for the electric motor is operated by two alternating power circuits, each has a battery and that while one circuit is operating the electric motor from its associated battery, the other circuit allows its associated battery to be recharged. Thus, when the battery of the first circuit is low in power supply, the second circuit is alternately activated, thus allowing its battery to operate the motor, while the battery of the first circuit is recharged. Presently, no known method has been designed to solve this Achilles heel of the electric vehicle industry, which is a mechanism that will be built to provide the battery a continuous supply of electricity for the vehicle. The present applicant's conception is a process in which an electric induction motor of an electric vehicle can operate without the need to recharge at designated charging stations or main electric grid and thus provide a continued supply of electricity to the electric vehicle.

### SUMMARY OF THE INVENTION

The present invention as herein disclosed has the objective of providing an improvement in the power supply-to an electric vehicle that will make it possible to drive a vehicle without recharging at a recharging station. The conception comprises attaching a spinning fan or a rotary flywheel to a shaft that is attached to an alternating circuit induction motor with wires connecting directly from this motor to the positive and negative poles of the traction battery unit/pack of electric vehicle, which acts as input power supply point of the vehicle (see diagram). This allows the alternator immediately to supply continuous electricity to the battery pack as it sends its power to provide power to the vehicle (as the loss is replaced by power from the alternator to the battery pack) thus, making the vehicle is still operative despite the distance it had covered (It is like giving a jump start to a vehicle that has lost its power supply or just like working on a laptop with its battery being charged through the main electric grid).

Thus, people can apply a similar principle to an alternating circuit induction motor and the battery pack by attaching wires from the motor to the negative and positive poles of the battery pack/unit. The receiving side is the input side (positive pole) where the alternating induction motor supplies power to the battery unit from where it is sent through the output side (negative pole) to the controller that distributes this power to other parts for the vehicle to be operative. It is like wind turbine that turns an alternating circuit induction motor that produces electricity that is used at a house where the battery is recharged using grid electricity, either from a wall socket or a dedicated charging unit. (What if the house electricity recharges the battery pack from the mains is for example attached to and carried by the electric vehicle, what will happen? Will the electric car battery run down with no electricity to power the car? Let us think of that).

Another objective is to provide an inexpensive way for the installation of the parts needed for electric vehicles as some vehicle owners park their cars outside as they do not have garages.

Furthermore, the installation of the parts (the rotary fan or flywheel, shaft, wires, and alternating circuit induction motor) does not demand a big space in the vehicle and old models can be upgraded with these for embodiments. The process is like using a wind turbine to generate electricity for a house and charging the battery pack with the electricity from the house (see bracketed sentences).

### BRIEF DESCRIPTION OF THE DRAWING FIGURES

FIG. 1 is a perspective view of the assembly of the various parts in a manner taught by this invention and the necessary connections that are needed for the operation of this invention (claim 1).

FIG. 2 is the top plan view of this invention that provides a detail of the portion of claim 1 which must have this assembly.

FIG. 3 is a perspective view of the-assembly of the various parts in a manner taught by this invention and the necessary connections that are needed for the operation of this invention (claim 2).

FIG. 4 is the top view of this invention which details the portion of claim 2 which must have this assembly.

### DETAILED DESCRIPTION OF THE PREFERRED EMBODIMENT (CLAIM 1)

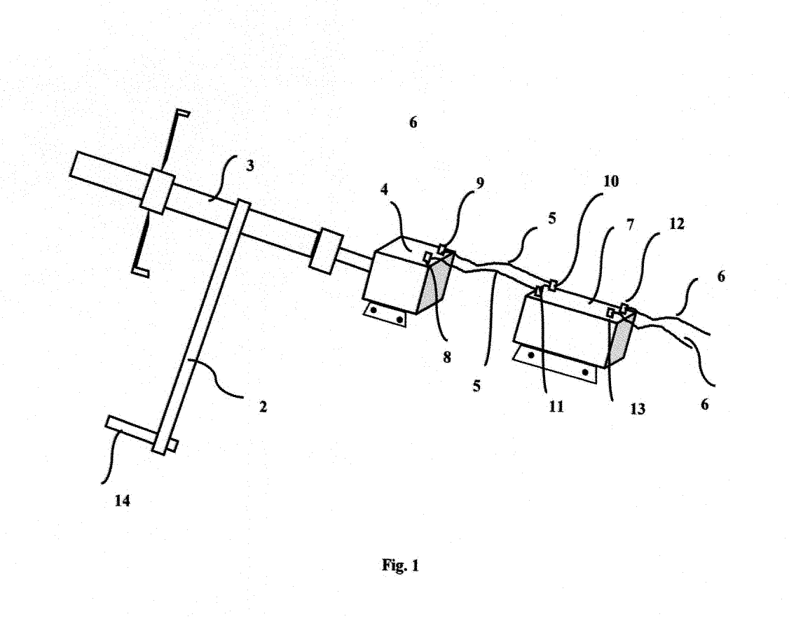

In reference to the drawings, wherein the reference numerals are a representation of similar parts throughout all the various drawing figures, this description is directed towards the assembly of this invention, which is a continuous power supply for electric vehicles where the perspective view is shown in FIG. 1 (claim 1). Thus, with a particular reference to FIG. 1, this invention, a method when assembled in this manner to supply a continuous supply of electricity, includes a spinning fan/flywheel 1. The spinning fan or flywheel 1 is attached to a shaft 3 that is attached to and is coupled to alternator 4 and shaft 3 such that these attachments can revolve freely when belt 2 turns. A rigid belt 2 attached to shaft 3 connects turning part 14. In the assembly, fan 1, shaft 3, and alternator 4 can all rotate freely when the ignition of the car is turned on and excites turning part 14 and engages components: 2, 3, and 4 such that all these turn/moves to make the vehicle operative.

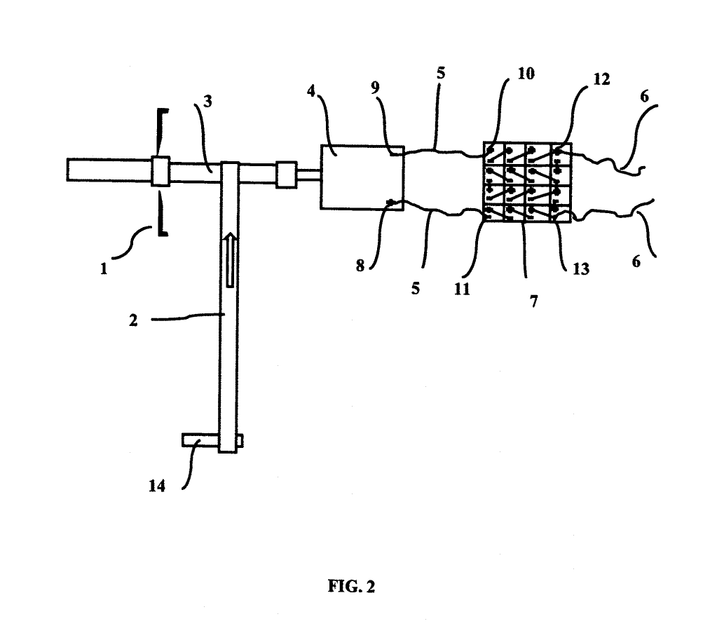

FIG. 2 (claim 1) shows the plan of the assembly and the necessary connections of the invention. The turning part 14 is excited when the ignition of the vehicle is turned on. Part 2, the belt, attached to part 14 is excited, turns, and engages the shaft 3, which has as attachments the spinning fan or flywheel 1, the belt 2 and the alternator 4. Thus, as alternator 4 turns, it generates electricity that goes through wires 5 to the battery pack 7. Part 4 has two terminal poles—one positive 8 and the other negative 9 that are connected by wires 5 to one side of the battery pack 7 that has four terminal poles; two, one positive 10 and the other negative 11 on one side and another two, the positive one 12 and negative one 13 on the other side.

Thus, the opposite terminal ends 8 and 11 are connected, and 9 and 10 are connected. This connection will allow electricity to flow from the alternator 4 through the wires S to charge the battery 7 so that the vehicle will not lose its supply of electricity and therefore power; the vehicle will continue to travel. Wires 6 connect the two terminal poles 12 and 13 of the other end of the battery pack 7 to the controller so that the controller will distribute the power to all the parts of the vehicle such as lights.

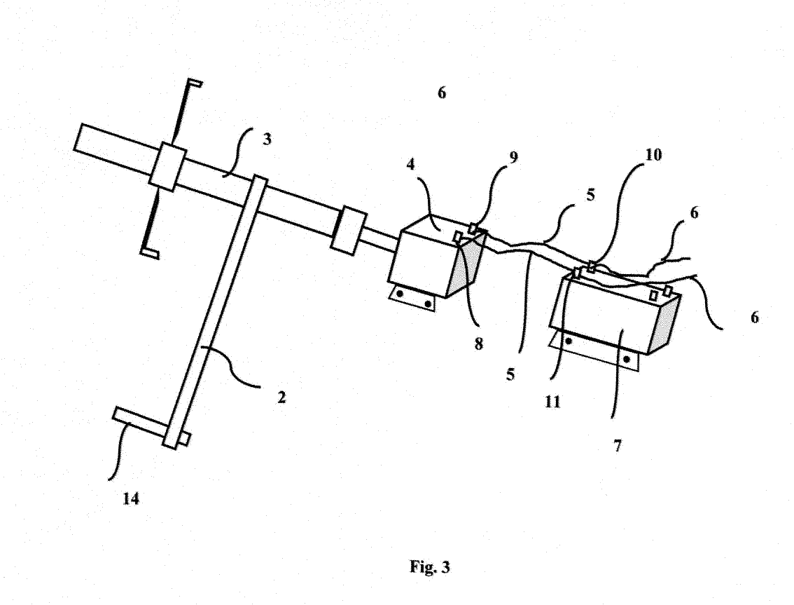

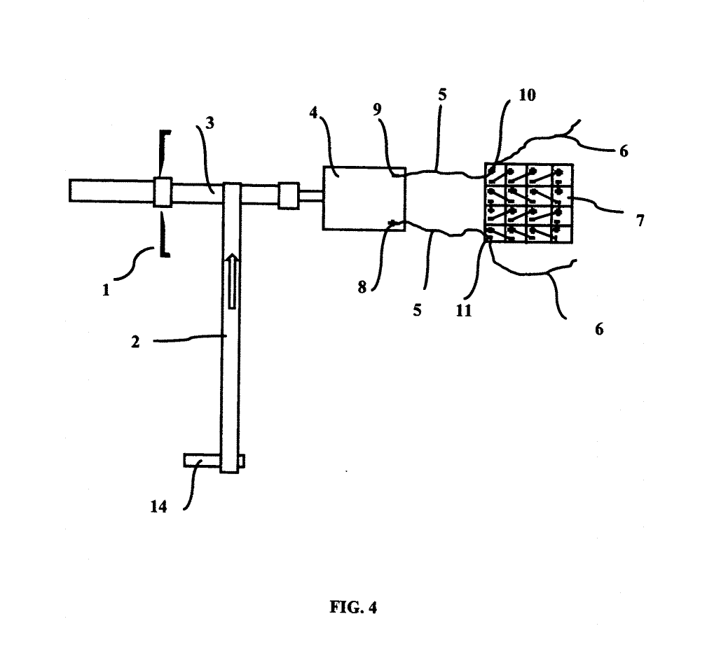

In claim 2, (FIGS. 3 and 4) the operation follows that of claim 1 except that after the alternator 4 has wires 5 connected from 9 to the positive terminal pole 10 and from 8 to negative terminal pole 11; wires 6 connect electricity from pole 10 and pole 11 to the controller for distribution to make the vehicle operative.

### DESCRIPTION OF THE DRAWING

The advantages of the current method will be easily understood concerning the following specifications and attached drawings, FIGS. 1 and 2. In FIGS. 1, the perspective drawing and FIG. 2, the view from above or the plan has these major components: a spinning fan or flywheel 1 activated by a turning part 14 by a belt 2, a shaft 5 connects the fan/flywheel 1 and the alternating induction motor 4, and the alternating circuit motor 4 is connected by a shaft 3, electrical wires 5 connect the positive pole 8 and negative pole 9 of the alternating circuit induction motor 4 to the battery pack 7, wires 6 connect from the battery pack 7 to supply power to the vehicle, that is wires 6 will supply electricity to the controller of the vehicle.

It is these integrated and attached components that will generate uninterrupted power supply to an electric vehicle. The fan/flywheel 1 that is spinning is connected to a shaft 3, and this shaft connects and turns the alternating circuit motor 4; the alternating circuit induction motor generates electricity, and the wires 5 that connect the positive pole 8 and negative pole 9 of the alternator to the positive pole 10 and negative pole 11 of the battery pack 7 on one side and positive pole 12 and negative pole 13 on the other side of the battery pack 7; wires 6 take electricity to the controller to distribute the power to all parts of the vehicle to allow the vehicle to move and be in operation.

The spinning fan or flywheel 1 once it is activated when the belt 2 is connected to spinning part 14, belt 2 engages the shaft/rod 3 that is attached to the alternating circuit induction motor 4. As the fan/flywheel 1 rotates, the air the fan 1 blows cools the motor 4 (which can become hot); the alternating induction motor 4 that is attached to the shaft/rod 3 becomes operative and delivers its electricity to the battery pack 7 by the wires 5 to the controller (see FIGS. 1, 2, 3 and 4) for distribution to make the vehicle operative.

As the vehicle starts, the battery pack 7 is drained of some of its charge as it outputs the electricity to the controller to power the vehicle (because the car depends on it to move) and the alternator 4 resupplies electricity to replace that which was lost by the battery pack 7. Thus, the vehicle is automatically provided the needed motive power to be operative just as a laptop that is being charged has the power that a person uses to work with while it (the laptop) is being charged. When the alternating circuit induction motor 4 supplies electric charge to the battery pack 7 (it is like jump starting a vehicle that has lost its power to start), the vehicle, therefore, receives a continuous supply of electric power that is necessary for the vehicle's operation. Because the vehicle is receiving this continuous supply of power, this electric vehicle does not need to stop to recharge (because of the alternating circuit induction motor 4 is replenishing the difference by charging the battery 7 through its wires 5 that are connected to the positive pole 10 and negative pole 11 of the battery pack 7) and from there the wires 6 connect the electricity to the controller for distribution to make the vehicle operative.

This becomes a system as the power that is stored in the battery pack 7 is used, this lost power is replenished by the electricity generated by the alternating induction motor 4 and the battery pack 7 has the power that is sent to the controller to make the vehicle to be operative. The difference between the main electricity from the house and that of the electric vehicle is that while the electricity that comes from the house is from a stationary main, electricity for the vehicle's battery pack 7 is from a mounted alternating circuit induction motor 4 (generated by the rotating fan or flywheel 1 spinning an alternating circuit induction motor 4) to the battery pack.

### DETAILED DESCRIPTION

The current invention relates to the motive power of an electric vehicle. This power source is electricity already stored in a battery pack that can be used up according to the current models that are in operation. Thus, in the current models of the vehicle, a continued supply of motive power for an electric vehicle is absent because the electricity is used up and the battery becomes flat, and it is unable to make the vehicle operative and must be recharged. This recharging of the battery pack occurs at recharging stations or garages. This go-stop-and-go situation is a key difficulty in the operation of electric vehicles. However, this method that propose is designed to ensure that electric vehicles do not need to stop at recharging stations or even at garages to add cost to the house electric bill (also for those who do not own houses but want to drive electric vehicles).

The solution lies in attaching a belt connected to a turning part and attached to a shaft 3 that has rotating fan or flywheel 1 (the fan will cool the alternator so that it will not be overheated) that is coupled to an alternating circuit induction motor 4 that has wires l connected to the positive pole 8 and negative pole 9 of the alternator and from positive 8 to negative 11 and from negative 9 to the positive pole 10 of the battery pack 7; and from the positive pole 12 and the negative pole 13 to the controller to power the vehicle through wires 6. The alternating circuit induction motor thus will generate electricity continuously to replace that which was used by the vehicle; otherwise the vehicle will stop. The supply of electricity from the alternating circuit induction motor 4 to the battery pack 7 will act as giving a jumpstart to a vehicle, replacing the lost power from the battery pack 7 and this will enable the vehicle to continue its movement.

The four figures, FIGS. 1 and 2 for claim 1 and FIGS. 3 and 4 for claim 2.

### REFERENCES:

Durbin, Dee-Ann. (2017), Associated Press, Aug. 14, 2017
Rippel, Wally (2007). Roadster and Electric: Induction Versus DC Brushless Motors.
Whitburn, Greg. (2017). How does wind energy work?
www.exploringgreentechnology.com
Woodford, Chris. (2017). Electric Cars—batteries.
http://www.explainthatstuff.com/electriccars.html

Patent Citations

| Cited Patent | Filing date | Publication date | Applicant | Title: |
|---|---|---|---|---|
| U.S. Pat. No. 4,348,628 A | Oct. 19, 1981 | Sep. 7, 1982 | Carl C Loucks | Electric motor |
| | | | | alternating |
| | | | | power supply |
| | | | | for vehicles |
| Cited Patent | Filing date | Publication date | Inventors | Title: |
| US 20100123352 A1 | Nov. 18, 2008 | May 20, 2010 | Dean S. Elleman, | Hybrid power |
| | | | Gordon Helm | system for a vehicle |
| Cited Patent | Filing date | Publication date | Applicant | Title: |
| EP 0340913 A2 | Apr. 6, 1989 | Nov. 8, 1989 | General Electric | Dual generator |
| | | | Motors | electrical apparatus |

New References

| Patent Citations | Filing Date | Publication Date | Applicant | Title |
|---|---|---|---|---|
| U.S. Pat. No. 7,614,586 B2 | Mar. 10, 2006 | Feb. 8, 2007 | John Marchel Powell | Method of |
| | | | | Traveling to |
| | | | | Earth's Orbit |
| | | | | using Lighter |
| | | | | than Air Vehicles |
| Patent Number | Filing Date | Date of Patent | Applicant | Title |
| U.S. Pat. No. 5,984,487 | May 14, 1997 | Nov. 16, 1999 | Dwight A. McGhee | Bicycle Visibility |
| | | | | Enhancement |
| | | | | Device |
| U.S. Pat. No. 5,904,116 | May 21, 1997 | May 18, 1999 | Stewart A. Wyner; | Revolving Pennant |
| | | | Donna M Purcell | |
| U.S. Pat. No. 5,971,438 | Nov. 16, 1998 | Oct. 26, 1999 | Albert P. Johnson | Mobile Vehicle |
| | | | | Sewage Removal |
| | | | | System |
| Patent Number | Filing Date | Date of Patent | Applicants | Title |
| U.S. Pat. No. 7,662,004 B1 | Nov. 14, 2007 | Feb. 16, 1010 | Philip A. March | Human-Powered |
| | | | John R. Ridgely | Flapping Hydrofoil |
| | | | Sherwood P. Gibson | Craft |
| | | | Peter R. March | |

1. The idea of using an alternating induction motor that will generate electricity to replace that which was lost from the battery pack; a process that comprises an attachment of a spinning fan/flywheel that is attached to a shaft to an alternating circuit induction motor that has its positive pole and negative pole attached directly by wires to the positive and negative poles of the battery pack of the vehicle; electricity the alternator generates consequently replaces the power supply in the battery pack; the battery pack sends its power to the controller thus providing continuous supply of power to make the vehicle operative without using a recharging station or the main electric grid (to recharge the battery pack/unit); and

2. I claim a battery pack with one side as the input with positive and negative poles and has wires from the alternating circuit induction motor and the other side of the battery pack with negative and positive poles at the output section, that has wires that connect to the controller to supply power to run the vehicle.
